(19) United States
(12) Patent Application Publication
(10) Pub. No.: US 2020/0021144 A1
(43) Pub. Date: Jan. 16, 2020

(54) METHOD AND SYSTEM FOR REDUCING MAGNETIC FIELD EMISSIONS FROM DOUBLE-D COUPLERS

(71) Applicant: WiTricity Corporation, Watertown, MA (US)

(72) Inventors: Mickel Bipin BUDHIA, Auckland (NZ); Wojciech CHLEBOSZ, Taufkirchen (DE); Leandro PERCEBON, Munich (DE)

(21) Appl. No.: 16/035,950

(22) Filed: Jul. 16, 2018

(51) Int. Cl. H02J 50/70; H02J 7/02; H02J 50/12; H01F 38/14; H01F 27/38; B60L 11/18

(52) U.S. Cl. CPC H02J 50/70; H02J 7/025; H02J 50/12; H02J 50/80; H01F 27/38; B60L 11/182; H01F 38/14

(57) ABSTRACT

In certain aspects, methods and systems for reducing magnetic field emissions from double-D inductive couplers are disclosed. Certain aspects of the present disclosure provide a power transfer device for reducing magnetic field emissions. The power transfer device generally includes a first coil and a second coil configured to generate a charging field; and at least one auxiliary coil coupled in series with at least one of the first coil or the second coil, the at least one auxiliary coil being configured to reduce magnetic field emission of the charging field.

### FIELD

This application is generally related to wireless power charging, and specifically to methods and apparatus for reducing magnetic field emissions from double-D inductive couplers.

### BACKGROUND

Remote systems, such as vehicles, have been introduced that include locomotion power derived from electricity received from an energy storage device, such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless power charging systems that are capable of transferring power in free space (e.g., via a wireless field) to be used to charge electric vehicles may overcome some of the deficiencies of wired charging solutions. As such, wireless power charging systems and methods that efficiently and safely transfer power for charging electric vehicles are desirable.

Inductive power transfer (IPT) systems are one means for the wireless transfer of energy. In IPT, a primary (or “base”) power device (e.g., a base pad, base wireless charging system, or some other wireless power transfer device including a power transfer element (e.g., base power transfer element)) transmits power to a secondary (or “pick-up”) power receiver device (e.g., a vehicle pad, an electric vehicle wireless charging unit, or some other wireless power receiving device including a power transfer element (e.g., vehicle power transfer element)). Each of the transmitter and receiver power devices includes inductors, typically coils or windings of electric current conveying media. An alternating current in the primary inductor produces a fluctuating magnetic field. When the secondary inductor is placed in proximity to the primary inductor, the fluctuating magnetic field induces an electromotive force (EMF) in the secondary inductor, thereby transferring power to the secondary power receiver device.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved wireless power transfer.

Certain aspects of the present disclosure provide a power transfer device. The power transfer device generally includes a first coil and a second coil configured to generate a charging field; and at least one auxiliary coil coupled in series with at least one of the first coil or the second coil, the at least one auxiliary coil being configured to reduce magnetic field emission of the charging field.

Certain aspects of the present disclosure provide an apparatus for wireless electric vehicle charging. The apparatus generally includes a first coil and a second coil configured to at least one of generate or receive a charging field; a layer of ferrite material below the first and second coils; and at least one auxiliary coil coupled in series with at least one of the first coil or the second coil, the at least one auxiliary coil being configured to reduce magnetic field emissions of the charging field.

Certain aspects of the present disclosure provide a method of wireless electric charging. The method generally includes energizing a plurality of coils to generate a charging field, the plurality of coils comprising a first coil, a second coil, and at least one auxiliary coil coupled in series with at least one of the first coil or the second coil, the at least one auxiliary coil being configured to reduce magnetic field emissions of the charging field; and wirelessly transferring charging power via the charging field.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a wireless power transfer system for charging an electric vehicle, according to certain aspects of the present disclosure.

FIG. 2 is a schematic diagram of exemplary components of the wireless power transfer system of FIG. 1, according to certain aspects of the present disclosure.

FIG. 3 is a functional block diagram showing exemplary components of the wireless power transfer system of FIG. 1, according to certain aspects of the present disclosure.

FIG. 4A is a perspective view of a layout of an exemplary power transfer device, according to certain aspects of the present disclosure.

FIG. 4B is a top view of a layout of the power transfer device of FIG. 4A, illustrating current flow therein, according to certain aspects of the present disclosure.

FIG. 5A is a conceptual diagram of exemplary winding paths implemented for the power transfer device of FIGS. 4A and B, in accordance with certain aspects of the present disclosure.

FIG. 5B illustrates a cross-sectional view of the winding paths of FIG. 5A, in accordance with certain aspects of the present disclosure.

FIG. 6 illustrates a diagram of exemplary magnetic field emissions generated by a power transfer device without an auxiliary coil.

FIG. 7 depicts a diagram of exemplary magnetic field emissions generated by a power transfer device utilizing auxiliary coils, in accordance with certain aspects of the present disclosure.

FIG. 8 shows a cross-sectional view of exemplary winding paths of a power transfer device, in accordance with certain aspects of the present disclosure.

FIG. 9A illustrates a top view of a layout of an exemplary power transfer device utilizing solenoid coils as the auxiliary coils, in accordance with certain aspects of the present disclosure.

FIG. 9B shows a cross-sectional view of the winding paths of the device of FIG. 9A, in accordance with certain aspects of the present disclosure.

FIG. 10 shows a layout of an exemplary power transfer device having shorter solenoid coils, in accordance with certain aspects of the present disclosure.

FIG. 11 depicts a layout of an exemplary power transfer device having solenoid coils arranged in the interior of the double-D coils, in accordance with certain aspects of the present disclosure.

FIG. 12 depicts a cross-sectional view of an exemplary power transfer device having tilted solenoid coils, in accordance with certain aspects of the present disclosure.

FIG. 13 is a flowchart illustrating example operations for wireless electric charging, in accordance with certain aspects of the present disclosure.

### DETAILED DESCRIPTION

The detailed description set forth below in connection with the appended drawings is intended as a description of exemplary implementations and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations. In some instances, some devices are shown in block diagram form.

### Example Wireless Power Charging System

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include, besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

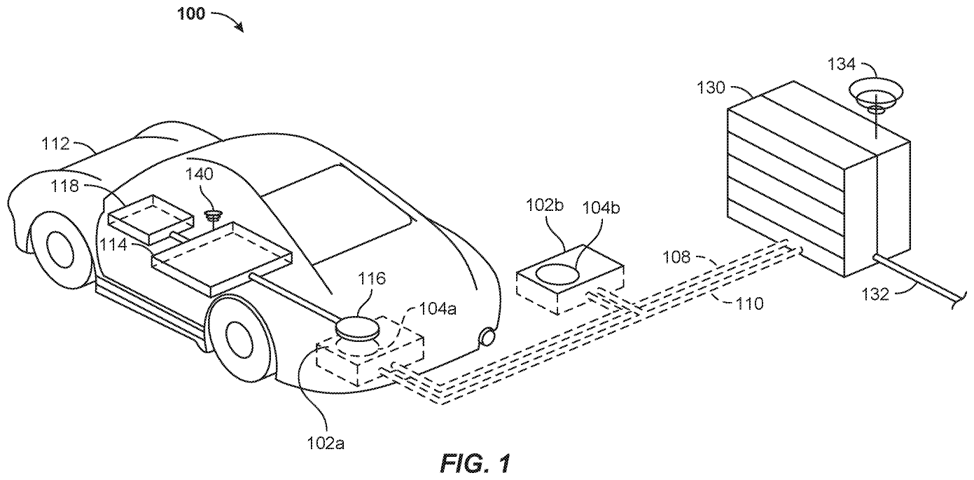

FIG. 1 is a diagram of an exemplary wireless power transfer system 100 for charging an electric vehicle, in accordance with some exemplary implementations. The wireless power transfer system 100 enables charging of an electric vehicle 112 while the electric vehicle 112 is parked so as to efficiently couple with a base wireless charging system 102a. Spaces for two electric vehicles are illustrated in a parking area to be parked over corresponding base wireless charging systems 102a and 102b. In some implementations, a local distribution center 130 may be connected to a power backbone 132 and configured to provide an alternating current (AC) or a direct current (DC) supply through a power link 110 to the base wireless charging systems 102a and 102b. Each of the base wireless charging systems 102a and 102b also includes a base power transfer element 104a and 104b, respectively, for wirelessly transferring power. In some other implementations (not shown in FIG. 1), base power transfer elements 104a or 104b may be stand-alone physical units and are not part of the base wireless charging system 102a or 102b.

The electric vehicle 112 may include a battery unit 118, an electric vehicle power transfer element 116, and an electric vehicle wireless charging unit 114. The electric vehicle wireless charging unit 114 and the electric vehicle power transfer element 116 constitute the electric vehicle wireless charging system. In some diagrams shown herein, the electric vehicle wireless charging unit 114 is also referred to as the vehicle charging unit (VCU). The electric vehicle power transfer element 116 may interact with the base power transfer element 104a for example, via a region of the electromagnetic field generated by the base power transfer element 104a.

In some exemplary implementations, the electric vehicle power transfer element 116 may receive power when the electric vehicle power transfer element 116 is located in an electromagnetic field produced by the base power transfer element 104a. The field may correspond to a region where energy output by the base power transfer element 104a may be captured by the electric vehicle power transfer element 116. For example, the energy output by the base power transfer element 104a may be at a level sufficient to charge or power the electric vehicle 112. In some cases, the field may correspond to a “near-field” of the base power transfer element 104a. The near-field may correspond to a region in which there are strong reactive fields resulting from the currents and charges in the base power transfer element 104a that do not radiate power away from the base power transfer element 104a. In some cases the near-field may correspond to a region that is within about ½π of a wavelength of the a frequency of the electromagnetic field produced by the base power transfer element 104a distant from the base power transfer element 104a, as will be further described below.

The electric vehicle power transfer element 116 and base power transfer element 104 as described throughout the disclosed implementations may be referred to or configured as “loop” antennas, and more specifically, multi-turn loop antennas. The elements 104 and 116 may also be referred to herein or be configured as “magnetic” antennas. The term “power transfer element” is intended to refer to a component that may wirelessly output or receive energy for coupling to another “power transfer element.” The power transfer element may also be referred to as an “antenna” or a “coupler” of a type that is configured to wirelessly output or receive power. As used herein, power transfer elements 104 and 116 are examples of “power transfer components” of a type that are configured to wirelessly output, wirelessly receive, and/or wirelessly relay power. Loop (e.g., multi-turn loop) antennas may be configured to include an air core or a solid core such as a ferrite core. An air core loop antenna may allow the placement of other components within the core area. Solid core antennas including ferromagnetic or ferrimagnetic materials may allow development of a stronger electromagnetic field and improved coupling.

Local distribution center 130 may be configured to communicate with external sources (e.g., a power grid) via a communication backhaul 134, and with the base wireless charging system 102a via a communication link 108.

In some implementations, the electric vehicle power transfer element 116 may be aligned with the base power transfer element 104a and, therefore, disposed within a near-field region simply by the electric vehicle operator positioning the electric vehicle 112 such that the electric vehicle power transfer element 116 is sufficiently aligned relative to the base power transfer element 104a. Alignment may be considered sufficient when an alignment error has fallen below a tolerable value. In other implementations, the operator may be given visual and/or auditory feedback to determine when the electric vehicle 112 is properly placed within a tolerance area for wireless power transfer. In yet other implementations, the electric vehicle 112 may be positioned by an autopilot system, which may move the electric vehicle 112 until the sufficient alignment is achieved. This may be performed automatically and autonomously by the electric vehicle 112 with or without driver intervention. This may be possible for an electric vehicle 112 that is equipped with a servo steering, radar sensors (e.g., ultrasonic sensors), and intelligence for safely maneuvering and adjusting the electric vehicle. In still other implementations, the electric vehicle 112 and/or the base wireless charging system 102a may have functionality for mechanically displacing and moving the power transfer elements 116 and 104a, respectively, relative to each other to more accurately orient or align them and develop sufficient and/or otherwise more efficient coupling therebetween.

The base wireless charging system 102a may be located in a variety of locations. As non-limiting examples, some suitable locations include a parking area at a home of the electric vehicle owner, parking areas reserved for electric vehicle wireless charging modeled after conventional petroleum-based filling stations, and parking lots at other locations, such as shopping centers and places of employment.

Charging electric vehicles wirelessly may provide numerous benefits. For example, charging may be performed automatically, virtually without driver intervention or manipulation thereby improving convenience to a user. There may also be no exposed electrical contacts and no mechanical wear out, thereby improving reliability of the wireless power transfer system 100. Safety may be improved since manipulations with cables and connectors may not be needed and there may be no cables, plugs, or sockets to be exposed to moisture in an outdoor environment. In addition, there may also be no visible or accessible sockets, cables, or plugs, thereby reducing potential vandalism of power charging devices. Further, since the electric vehicle 112 may be used as distributed storage devices to stabilize a power grid, a convenient docking-to-grid solution may help to increase availability of vehicles for vehicle-to-grid (V2G) operation.

The wireless power transfer system 100 as described with reference to FIG. 1 may also provide aesthetical and non-impedimental advantages. For example, there may be no charge columns and cables that may be impedimental for vehicles and/or pedestrians.

As a further explanation of the vehicle-to-grid capability, the wireless power transmit and receive capabilities may be configured to be reciprocal such that either the base wireless charging system 102a can transmit power to the electric vehicle 112 or the electric vehicle 112 can transmit power to the base wireless charging system 102a. This capability may be useful to stabilize the power distribution grid by allowing electric vehicles 112 to contribute power to the overall distribution system in times of energy shortfall caused by over demand or shortfall in renewable energy production (e.g., wind or solar).

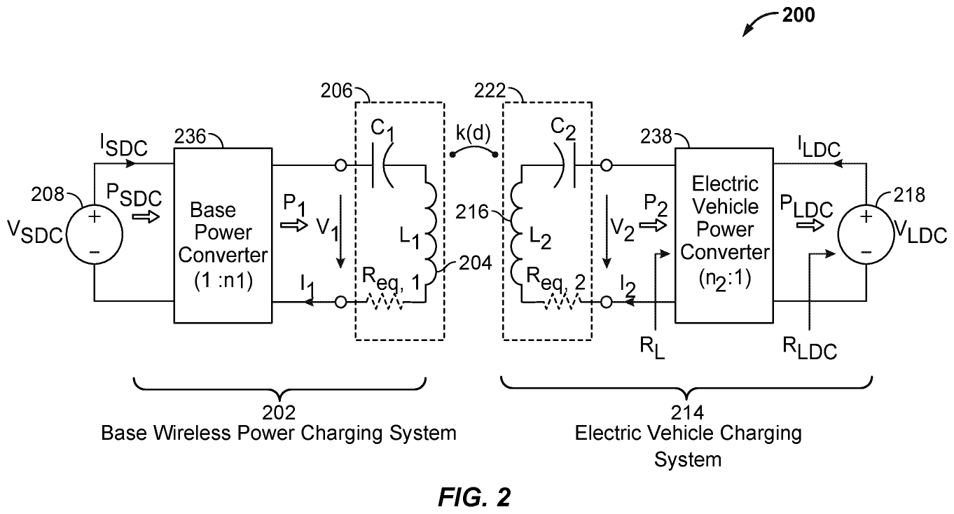

FIG. 2 is a schematic diagram of exemplary components of a wireless power transfer system 200 similar to that previously discussed in connection with FIG. 1, in accordance with certain aspects of the present disclosure. The wireless power transfer system 200 may include a base resonant circuit 206 including a base power transfer element 204 having an inductance L1. The wireless power transfer system 200 further includes an electric vehicle resonant circuit 222 including an electric vehicle power transfer element 216 having an inductance L2. Implementations described herein may use capacitively loaded conductor loops (i.e., multi-turn coils) forming a resonant structure that is capable of efficiently coupling energy from a primary structure (transmitter) to a secondary structure (receiver) via a magnetic or electromagnetic near-field if both the transmitter and the receiver are tuned to a common resonant frequency. The coils may be used for the electric vehicle power transfer element 216 and the base power transfer element 204. Using resonant structures for coupling energy may be referred to as “magnetically coupled resonance,” “electromagnetically coupled resonance,” and/or “resonant induction.” The operation of the wireless power transfer system 200 will be described based on power transfer from a base power transfer element 204 to an electric vehicle 112 (not shown), but is not limited thereto. For example, as discussed above, energy may be also transferred in the reverse direction.

With reference to FIG. 2, a power supply 208 (e.g., AC or DC) supplies power P_{SDC} to the base power converter 236 as part of the base wireless power charging system 202 to transfer energy to an electric vehicle (e.g., electric vehicle 112 of FIG. 1). The base power converter 236 may include circuitry such as an AC-to-DC converter configured to convert power from standard mains AC to DC power at a suitable voltage level, and a DC-to-low frequency (LF) converter configured to convert DC power to power at an operating frequency suitable for wireless high power transfer. The base power converter 236 supplies power P1 to the base resonant circuit 206 including tuning capacitor C1 in series with base power transfer element 204 to emit an electromagnetic field at the operating frequency. The series-tuned resonant circuit 206 should be construed as exemplary. In another implementation, the capacitor C1 may be coupled with the base power transfer element 204 in parallel. In yet other implementations, the base resonant circuit 206 may be formed of several reactive elements in any combination of parallel or series topology. The capacitor C1 may be provided to form a resonant circuit with the base power transfer element 204 that resonates substantially at the operating frequency. The base power transfer element 204 receives the power P1 and wirelessly transmits power at a level sufficient to charge or power the electric vehicle. For example, the level of power provided wirelessly by the base power transfer element 204 may be on the order of kilowatts (kW) (e.g., anywhere from 1 kW to 110 kW, although actual levels may be or higher or lower).

The base resonant circuit 206 (including the base power transfer element 204 and tuning capacitor C1) and the electric vehicle resonant circuit 222 (including the electric vehicle power transfer element 216 and tuning capacitor C2) may be tuned to substantially the same frequency. The electric vehicle power transfer element 216 may be positioned within the near-field of the base power transfer element and vice versa, as further explained below. In this case, the base power transfer element 204 and the electric vehicle power transfer element 216 may become coupled to one another such that power may be transferred wirelessly from the base power transfer element 204 to the electric vehicle power transfer element 216. The series capacitor C2 may be provided to form a resonant circuit with the electric vehicle power transfer element 216 that resonates substantially at the operating frequency. The series-tuned resonant circuit 222 should be construed as being exemplary. In another implementation, the capacitor C2 may be coupled with the electric vehicle power transfer element 216 in parallel. In yet other implementations, the electric vehicle resonant circuit 222 may be formed of several reactive elements in any combination of parallel or series topology. Element k(d) represents the mutual coupling coefficient resulting at coil separation d. Equivalent resistances Req,1 and Req,2 represent the losses that may be inherent to the base and electric vehicle power transfer elements 204 and 216 and the tuning (anti-reactance) capacitors C1 and C2, respectively. The electric vehicle resonant circuit 222, including the electric vehicle power transfer element 216 and capacitor C2, receives and provides the power P2 to an electric vehicle power converter 238 of an electric vehicle charging system 214.

The electric vehicle power converter 238 may include, among other things, a LF-to-DC converter configured to convert power at an operating frequency back to DC power at a voltage level of the load 218 that may represent the electric vehicle battery unit. The electric vehicle power converter 238 may provide the converted power PLDC to the load 218. The power supply 208, base power converter 236, and base power transfer element 204 may be stationary and located at a variety of locations as discussed above. The electric vehicle load 218 (e.g., the electric vehicle battery unit), electric vehicle power converter 238, and electric vehicle power transfer element 216 may be included in the electric vehicle charging system 214 that is part of the electric vehicle (e.g., electric vehicle 112) or part of its battery pack (not shown). The electric vehicle charging system 214 may also be configured to provide power wirelessly through the electric vehicle power transfer element 216 to the base wireless power charging system 202 to feed power back to the grid. Each of the electric vehicle power transfer element 216 and the base power transfer element 204 may act as transmit or receive power transfer elements based on the mode of operation.

While not shown, the wireless power transfer system 200 may include a load disconnect unit (LDU) (not known) to safely disconnect the electric vehicle load 218 or the power supply 208 from the wireless power transfer system 200. For example, in case of an emergency or system failure, the LDU may be triggered to disconnect the load from the wireless power transfer system 200. The LDU may be provided in addition to a battery management system for managing charging to a battery, or it may be part of the battery management system.

Further, the electric vehicle charging system 214 may include switching circuitry (not shown) for selectively connecting and disconnecting the electric vehicle power transfer element 216 to the electric vehicle power converter 238. Disconnecting the electric vehicle power transfer element 216 may suspend charging and also may change the “load” as “seen” by the base wireless power charging system 202 (acting as a transmitter), which may be used to “cloak” the electric vehicle charging system 214 (acting as the receiver) from the base wireless charging system 202. The load changes may be detected if the transmitter includes a load sensing circuit. Accordingly, the transmitter, such as the base wireless charging system 202, may have a mechanism for determining when receivers, such as the electric vehicle charging system 214, are present in the near-field coupling mode region of the base power transfer element 204 as further explained below.

As described above, in operation, during energy transfer towards an electric vehicle (e.g., electric vehicle 112 of FIG. 1), input power is provided from the power supply 208 such that the base power transfer element 204 generates an electromagnetic field for providing the energy transfer. The electric vehicle power transfer element 216 couples to the electromagnetic field and generates output power for storage or consumption by the electric vehicle 112. As described above, in some implementations, the base resonant circuit 206 and electric vehicle resonant circuit 222 are configured and tuned according to a mutual resonant relationship such that the circuits are resonating nearly or substantially at the operating frequency. Transmission losses between the base wireless power charging system 202 and electric vehicle charging system 214 are minimal when the electric vehicle power transfer element 216 is located in the near-field coupling mode region of the base power transfer element 204 as further explained below.

As stated, an efficient energy transfer occurs by transferring energy via a magnetic near-field rather than via electromagnetic waves in the far field, which may involve substantial losses due to radiation into the space. When in the near-field, a coupling mode may be established between the transmit power transfer element and the receive power transfer element. The space around the power transfer elements where this near-field coupling may occur is referred to herein as a near-field coupling mode region.

While not shown, the base power converter 236 and the electric vehicle power converter 238 if bidirectional may both include, for the transmit mode, an oscillator, a driver circuit such as a power amplifier, a filter and matching circuit, and for the receive mode a rectifier circuit. The oscillator may be configured to generate a desired operating frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance as presented by the resonant circuits 206 and 222 to the base and electric vehicle power converters 236 and 238, respectively. For the receive mode, the base and electric vehicle power converters 236 and 238 may also include a rectifier and switching circuitry.

The electric vehicle power transfer element 216 and base power transfer element 204 as described throughout the disclosed implementations may be referred to or configured as “conductor loops,” and more specifically, “multi-turn conductor loops” or coils. The base and electric vehicle power transfer elements 204 and 216 may also be referred to herein or be configured as “magnetic” couplers. The term “coupler” is intended to refer to a component that may wirelessly output or receive energy for coupling to another “coupler.”

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency.

A resonant frequency may be based on the inductance and capacitance of a resonant circuit (e.g. resonant circuit 206) including a power transfer element (e.g., the base power transfer element 204 and capacitor C2) as described above. As shown in FIG. 2, inductance may generally be the inductance of the power transfer element, whereas, capacitance may be added to the power transfer element to create a resonant structure at a desired resonant frequency. Accordingly, for larger size power transfer elements using larger diameter coils exhibiting larger inductance, the value of capacitance needed to produce resonance may be lower. Inductance may also depend on a number of turns of a coil. Furthermore, as the size of the power transfer element increases, coupling efficiency may increase. This is mainly true if the size of both base and electric vehicle power transfer elements increase. Furthermore a resonant circuit including a power transfer element and tuning capacitor may be designed to have a high quality (Q) factor to improve energy transfer efficiency. For example, the Q factor may be 300 or greater.

As described above, according to some implementations, coupling power between two power transfer elements that are in the near-field of one another is disclosed. As described above, the near-field may correspond to a region around the power transfer element in which mainly reactive electromagnetic fields exist. If the physical size of the power transfer element is much smaller than the wavelength, inversely proportional to the frequency, there is no substantial loss of power due to waves propagating or radiating away from the power transfer element. Near-field coupling-mode regions may correspond to a volume that is near the physical volume of the power transfer element, typically within a small fraction of the wavelength. According to some implementations, magnetic power transfer elements, such as single and multi-turn conductor loops, are preferably used for both transmitting and receiving since handling magnetic fields in practice is easier than electric fields because there is less interaction with foreign objects, e.g., dielectric objects and the human body. Nevertheless, “electric” power transfer elements (e.g., dipoles and monopoles) or a combination of magnetic and electric power transfer elements may be used.

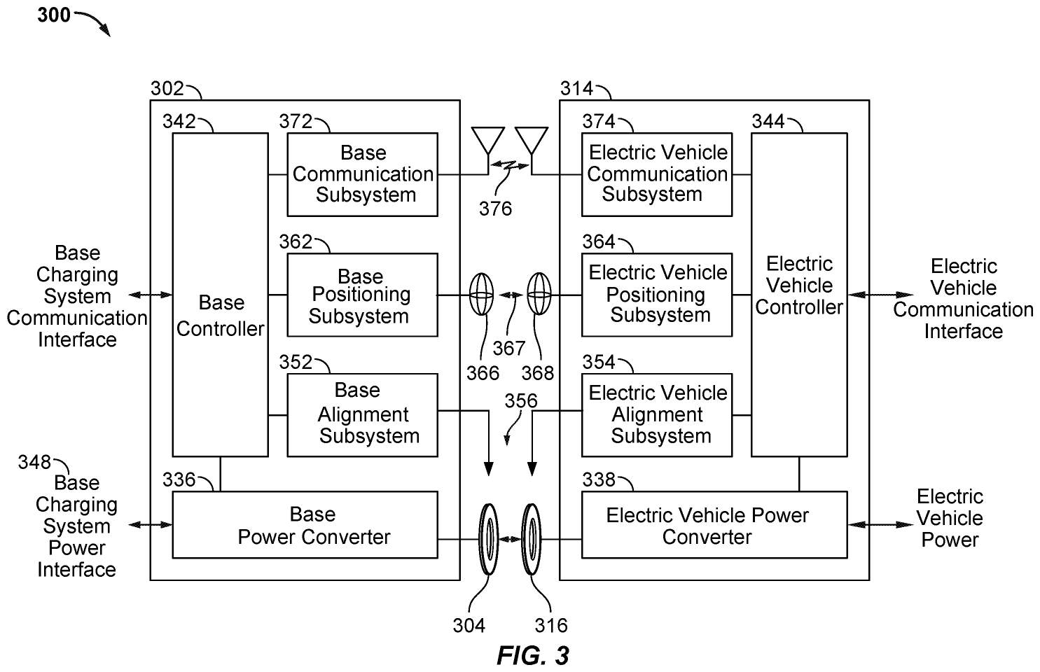

FIG. 3 is a functional block diagram showing exemplary components of wireless power transfer system 300, which may be employed in wireless power transfer system 100 of FIG. 1 and/or that wireless power transfer system 200 of FIG. 2 may be part of. The wireless power transfer system 300 illustrates a communication link 376, a positioning link 367, using, for example, a magnetic field signal for determining a position or direction, and an alignment mechanism 356 capable of mechanically moving one or both of the base power transfer element 304 and the electric vehicle power transfer element 316. Mechanical (kinematic) alignment of the base power transfer element 304 and the electric vehicle power transfer element 316 may be controlled by the base alignment subsystem 352 and the electric vehicle charging alignment subsystem 354, respectively. The positioning link 367 may be capable of bi-directional signaling, meaning that positioning signals may be emitted by the base positioning subsystem or the electric vehicle positioning subsystem or by both. As described above with reference to FIG. 1, when energy flows towards the electric vehicle 112, in FIG. 3 a base charging system power interface 348 may be configured to provide power to a base power converter 336 from a power source, such as an AC or DC power supply (not shown). The base power converter 336 may receive AC or DC power via the base charging system power interface 348 to drive the base power transfer element 304 at a frequency near or at the resonant frequency of the base resonant circuit 206 with reference to FIG. 2. The electric vehicle power transfer element 316, when in the near-field coupling-mode region, may receive energy from the electromagnetic field to oscillate at or near the resonant frequency of the electric vehicle resonant circuit 222 with reference to FIG. 2. The electric vehicle power converter 338 converts the oscillating signal from the electric vehicle power transfer element 316 to a power signal suitable for charging a battery via the electric vehicle power interface.

The base wireless charging system 302 includes a base controller 342 and the electric vehicle wireless charging system 314 includes an electric vehicle controller 344. The base controller 342 may provide a base charging system communication interface to other systems (not shown) such as, for example, a computer, a base common communication (BCC), a communications entity of the power distribution center, or a communications entity of a smart power grid. The electric vehicle controller 344 may provide an electric vehicle communication interface to other systems (not shown) such as, for example, an on-board computer on the vehicle, a battery management system, other systems within the vehicles, and remote systems.

The base communication subsystem 372 and electric vehicle communication subsystem 374 may include subsystems or circuits for specific application with separate communication channels and also for wirelessly communicating with other communications entities not shown in the diagram of FIG. 3. These communications channels may be separate physical channels or separate logical channels. As non-limiting examples, a base alignment subsystem 352 may communicate with an electric vehicle alignment subsystem 354 through communication link 376 to provide a feedback mechanism for more closely aligning the base power transfer element 304 and the electric vehicle power transfer element 316, for example via autonomous mechanical (kinematic) alignment, by either the electric vehicle alignment subsystem 354 or the base alignment subsystem 352, or by both, or with operator assistance.

The electric vehicle wireless charging system 314 may further include an electric vehicle positioning subsystem 364 connected to a magnetic field generator 368. The electric vehicle positioning subsystem 364 may be configured to drive the magnetic field generator 368 with currents that generate an alternating magnetic field. The base wireless charging system 302 may include a magnetic field sensor 366 connected to a base positioning subsystem 362. The magnetic field sensor 366 may be configured to generate a plurality of voltage signals under influence of the alternating magnetic field generated by the magnetic field generator 368. The base positioning subsystem 362 may be configured to receive these voltage signals and output a signal indicative of a position estimate and an angle estimate between the magnetic field sensor 366 and the magnetic field sensor 368. These position and angle estimates may be translated into visual and/or acoustic guidance and alignment information that a driver of the electric vehicle may use to reliably park the vehicle. In some implementations, these position and angle estimates may be used to park a vehicle automatically with no or only minimal driver intervention (drive by wire).

Further, electric vehicle controller 344 may be configured to communicate with electric vehicle onboard systems. For example, electric vehicle controller 344 may provide, via the electric vehicle communication interface, position data, e.g., for a brake system configured to perform a semi-automatic parking operation, or for a steering servo system configured to assist with a largely automated parking (“park by wire”) that may provide more convenience and/or higher parking accuracy as may be needed in certain applications to provide sufficient alignment between base and electric vehicle power transfer elements 304 and 316. Moreover, electric vehicle controller 344 may be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), and audio input devices (e.g., microphone with electronic voice recognition).

The wireless power transfer system 300 may also support plug-in charging via a wired connection, for example, by providing a wired charge port (not shown) at the electric vehicle wireless charging system 314. The electric vehicle wireless charging system 314 may integrate the outputs of the two different chargers prior to transferring power to or from the electric vehicle. Switching circuits may provide the functionality as needed to support both wireless charging and charging via a wired charge port.

To communicate between the base wireless charging system 302 and the electric vehicle wireless charging system 314, the wireless power transfer system 300 may use in-band signaling via base and electric vehicle power transfer elements 304, 316 and/or out-of-band signaling via communications systems (372, 374), e.g., via an RF data modem (e.g., Ethernet over radio in an unlicensed band). The out-of-band communication may provide sufficient bandwidth for the allocation of value-add services to the vehicle user/owner. A low depth amplitude or phase modulation of the wireless power carrier may serve as an in-band signaling system with minimal interference.

Some communications (e.g., in-band signaling) may be performed via the wireless power link without using specific communications antennas. For example, the base and electric vehicle power transfer elements 304 and 316 may also be configured to act as wireless communication antennas. Thus, some implementations of the base wireless charging system 302 may include a controller (not shown) for enabling keying type protocol on the wireless power path. By keying the transmit power level (amplitude shift keying) at predefined intervals with a predefined protocol, the receiver may detect a serial communication from the transmitter. The base power converter 336 may include a load sensing circuit (not shown) for detecting the presence or absence of active electric vehicle power receivers in the near-field coupling mode region of the base power transfer element 304. By way of example, a load sensing circuit monitors the current flowing to a power amplifier of the base power converter 336, which is affected by the presence or absence of active power receivers in the near-field coupling mode region of the base power transfer element 304. Detection of changes to the loading on the power amplifier may be monitored by the base controller 342 for use in determining whether to enable the base wireless charging system 302 for transmitting energy, to communicate with a receiver, or a combination thereof.

### Example Power Transfer Device for Reducing Magnetic Field Emissions

For some implementations, a base pad, an electric vehicle wireless charging unit, base wireless charging system 102, 202, 302, etc., or some other wireless power transfer device including a power transfer element (e.g., base power transfer element 104, 204, 304, etc.)) may be implemented with a double-D coupler, so-called due to the shape of the coils (i.e., two letter Ds). A double-D coupler provides enhanced magnetic flux relative to certain power transfer devices, such as a single coil coupler. That is, the double-D coupler offers improved power transfer, but as a result of this, the double-D coupler generates higher magnetic field leakage (e.g., a magnetic field that penetrates outside the range of the wireless power receiver). For instance, the double-D coupler produces a strong magnetic flux density (B-field) near the wireless power receiver (e.g., a vehicle pad, an electric vehicle wireless charging unit 114, 214, 314, etc., or some other wireless power receiving device including a power transfer element (e.g., vehicle power transfer element 116, 216, 316, etc.)) and a strong magnetic field intensity (H-field) away from the wireless power receiver. These strong B and H fields are referred to as magnetic field emissions and can cause issues with electronic devices (such as disturbances in pacemaker circuitry or interference with wireless communication devices).

Certain aspects of the present disclosure provide a double-D coupler with an auxiliary coil configured to reduce the magnetic field emissions that may disturb or interfere with electronic devices. For example, with the auxiliary coils arranged as described herein, the double-D coupler may result in a 30-60% reduction in the B-field emissions and a 7 dB reduction in H-field emissions.

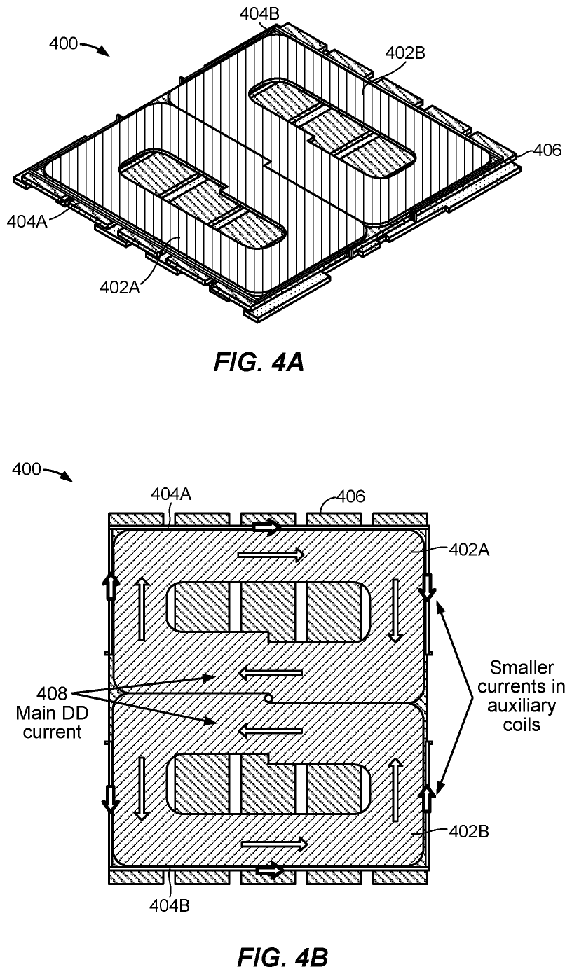

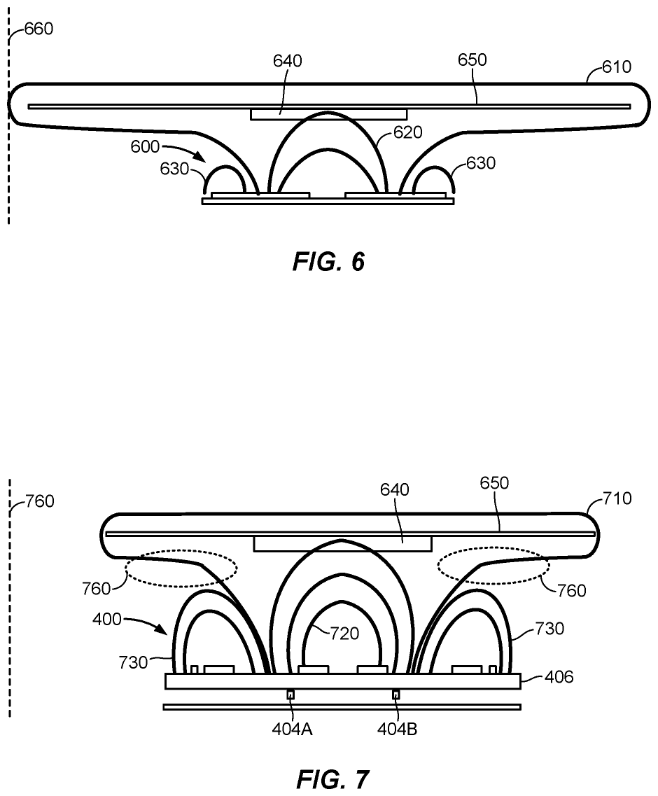

FIGS. 4A and B are layouts of an exemplary power transfer device 400 configured to reduce magnetic field emissions, in accordance with certain aspects of the present disclosure. As shown, the power transfer device 400 includes a double-D coil (also referred to as a “double-D coupler”). That is, the power transfer device 400 includes a first coil 402A and a second coil 402B (also referred to herein as “double-D coils”) configured to generate a strong charging field emitting from the main double-D current 408 as indicated by the current paths shown in FIG. 4B. Each of the first and second coils 402A, 402B may include one or more turns (i.e., windings) of an electrical conductor making up the coils. The first and second coils 402A, 402B may be wound in the same direction (e.g., both clockwise or both counterclockwise) or in different directions (e.g., one coil wound clockwise and the other coil wound counterclockwise). The first and second coils 402A, 402B are arranged side-by-side, such that when a current flows through adjacent turns of the first and second coils 402A, 402B in the same direction, a strong charging field is emitted from the first and second coils 402A, 402B, as further described herein with respect to FIGS. 6 and 7. The first coil 402A may be coupled in series with the second coil 402B. The first coil 402A may be arranged adjacent to the second coil 402B, such that an electric current is configured to flow in a same direction in adjacent turns of the first and second coils 402A, 402B. In certain aspects, the power transfer device 400 may be configured to perform wireless electric vehicle charging, such as described herein with respect to FIGS. 1-3, and implemented as a base pad or a vehicle pad. For instance, the power transfer device 400 may be a vehicle pad configured to energize a base pad or vice versa.

The power transfer device 400 also includes one or more auxiliary coils 404A, 404B coupled in series with at least one of the first coil 402A or the second coil 402B. The auxiliary coils 404A, 404B are configured to reduce the magnetic field emissions of the charging field generated by the double-D coils. As shown in FIGS. 4A and 4B, the auxiliary coil 404A is coupled in series with the first coil 402A, and the auxiliary coil 404B is coupled in series with the second coil 402B. For certain aspects, the power transfer device 400 may only include one auxiliary coil 404 configured to reduce magnetic field emissions from the edge of the charging device (e.g., the bumper of the vehicle). The electric current applied to the auxiliary coils 404A, 404B also flows in the same direction as the electric current applied to the first and second coils 402A, 402B as indicated by the arrows in FIG. 4B. The same amount of current may be applied to the auxiliary coils 404A, 404B as the first and second coils 402A, 402B. The auxiliary coil 404A, 404B may be a single-turn coil or a multi-turn coil.

The power transfer device 400 may also include a layer of ferrite material 406 arranged below the first and second coils 402A, 402B to concentrate and store the charging field. The ferrite material 406 may be implemented as strips of ferrite material. The auxiliary coils 404A, 404B may have winding paths such that a portion of the winding paths travel below the layer of ferrite material 406, resulting in the ferrite material 406 being between the auxiliary coils 404A, 404B and the first and second coils 402A, 402B in areas adjacent the portion of these winding paths. The other portion of the winding paths of the auxiliary coils 404A, 404B may be above the ferrite material 406 and may be on the same plane as the coils 402A, 402B.

The first and second coils 402A, 402B may be arranged to form various types of double-D couplers. For instance, the first and second coils 402A, 402B may be arranged side-by-side, as shown in FIGS. 4A and B, such that the coils do not overlap. Alternatively, the first and second coils 402A, 402B may be arranged such that the central windings (e.g., the adjacent turns) of the double-D overlap with each other to generate the charging field. The first and second coils 402A, 402B may also be arranged to overlap with each other such that the central winding of the first coil 402A is positioned in the interior of the second coil 402B, and vice versa. For example, portions of the top and bottom windings of the first and second coils 402A, 402B may overlap with each other, while portions of the central winding of the first coil 402A may be arranged to overlap with the interior of the second coil 402B, and vice versa.

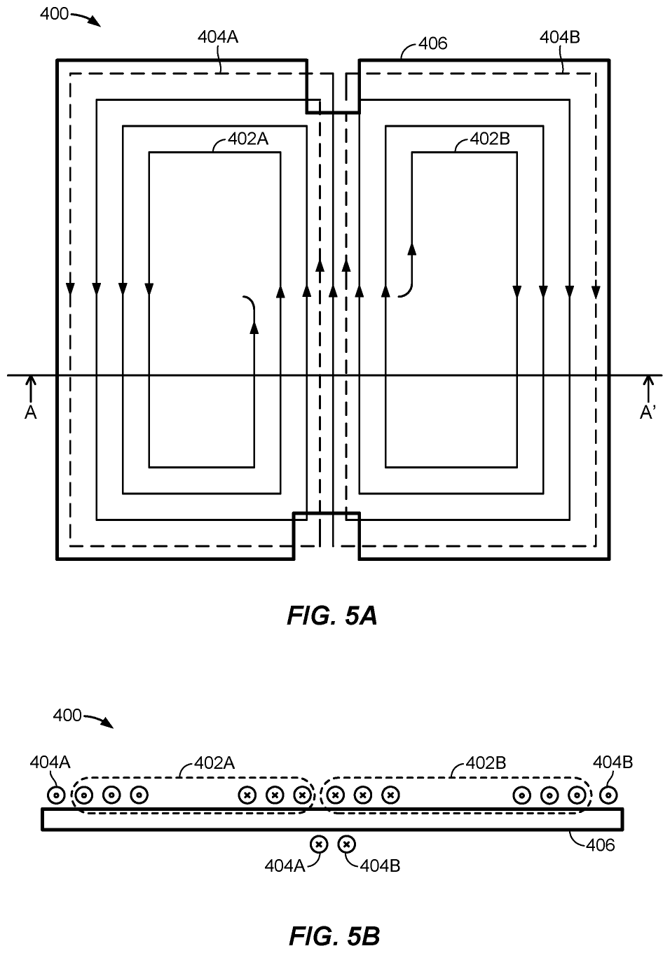

FIG. 5A depicts a layout of exemplary winding paths implemented for the power transfer device 400, in accordance with certain aspects of the present disclosure. As shown, the first coil 402A has a winding path in a counterclockwise direction, and the second coil 402B has a winding path in a clockwise direction. The first and second coils 402A, 402B may be wound in clockwise or counterclockwise directions as desired. For instance, the first coil 402A may include a first spiral wound in a counterclockwise direction, and the second coil 402B may include a second spiral wound in a clockwise direction. The arrows along the winding path of the coils 402A, 402B indicate the direction of current flow.

The auxiliary coils 404A, 404B are depicted as the dashed lines in series with their respective first and second coils 402A, 402B. FIG. 5A shows that each of the auxiliary coils 404A, 404B includes a winding path such that a first portion of the winding path (e.g., the inner portions of the auxiliary coils 404A, 404B) is laterally spaced closer to a main magnetic flux of the charging field arranged in the middle of the power transfer device 400 than a second portion of the winding path (e.g., the outer portions of the auxiliary coil 404A, 404B).

FIG. 5B depicts a cross-sectional view of the winding paths across the line segment A-A′ of FIG. 5A, in accordance with certain aspects of the present disclosure. As shown, a portion of each of the auxiliary coils 404A, 404B is arranged below the layer of ferrite material 406.

FIG. 6 depicts a diagram of magnetic field emissions generated by a power transfer device 600 without an auxiliary coil. As shown, the power transfer device 600 is a double-D coupler that produces a charging field 610 from a main magnetic field 620 and two side lobe magnetic fields 630. A receiver pad 640 (e.g., vehicle power transfer element 116, 216, 316, etc.) is positioned within the charging field 610 above the power transfer device 600 to receive power from the power transfer device 600. A shield plate 650 may also be positioned within the charging field 610 to reduce the magnetic field emissions of the charging field 610. FIG. 6 demonstrates that the power transfer device 600 provides enhanced magnetic flux in the region of the main magnetic field 620, but also results in magnetic field leakage beyond the shield plate 650. For instance, there are magnetic field emissions hot spots in the region spaced laterally from the power transfer device, such as the region intersecting the line 660. As this magnetic field leakage region may reside beyond the body of the vehicle or charging device, the magnetic field leakage may disturb or interfere with other electrical devices.

To reduce the leakage of magnetic field emissions, the power transfer device may utilize the auxiliary coils as described herein. For example, FIG. 7 depicts a diagram of magnetic field emissions generated by the power transfer device 400 utilizing auxiliary coils 404A, 404B, in accordance with certain aspects of the present disclosure. As shown, the power transfer device produces a charging field 710 resulting from a main magnetic field 720 (i.e., a main magnetic flux of the charging field) and two side lobe magnetic fields 730. The magnetic field strength is increased on the periphery of the power transfer device 400 (i.e., the side lobes 730) by adding an extra turn from the auxiliary coils 404A, 404B. The main magnetic field 720 does not increase because the adjacent, middle portions of the turns of the auxiliary coils 404A, 404B are under the ferrite layer 406 of the power transfer device 400. The auxiliary coils 404A, 404B reduce the magnetic flux density in the region intersecting line 760 and a similar region on the opposite side of the power transfer device 400. The effect of the auxiliary coils 404A, 404B is a higher magnetic pressure that makes it harder for the leakage flux to travel around the shield plate 650 (or vehicle not shown). The auxiliary coils 404A, 404B have been shown to reduce the magnetic flux density from a measurement point of about 10 meters (33 feet) spaced laterally from the power transfer device (such as along line 760) by about 30% to 60%. FIG. 7 demonstrates that there are reduced magnetic field emissions produced by the power transfer device 400 compared to the leakage hot spots of the power transfer device 600 of FIG. 6.

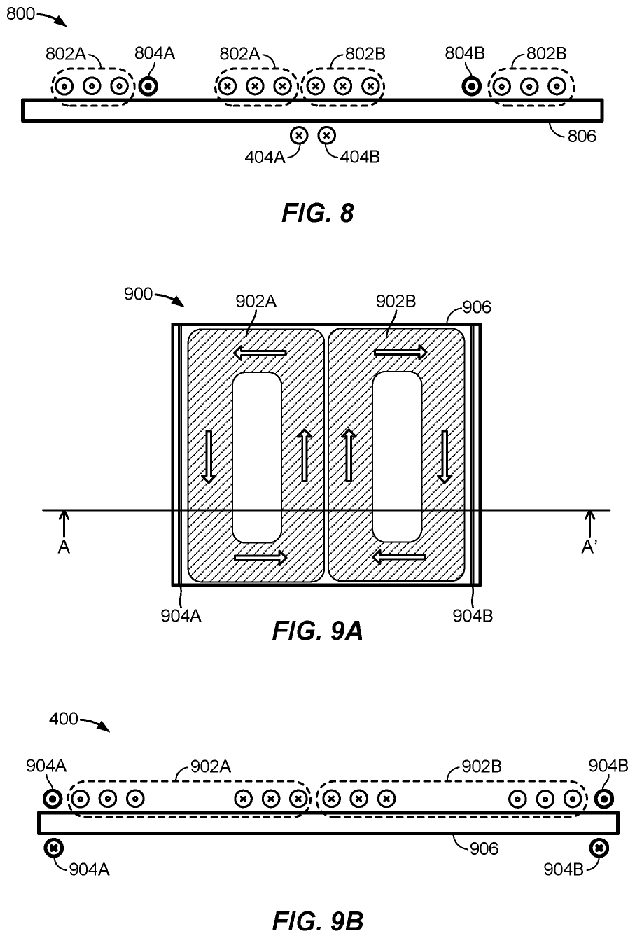

In certain aspects, a portion of the auxiliary coil may be positioned within an interior of the individual D coils of the double-D coupler. For example, FIG. 8 shows a cross-sectional view of exemplary winding paths of the power transfer device 800, where a portion of each of the auxiliary coils 804A, 804B travels within the interior of one respective D coil of the double-D coils 802A and 802B, in accordance with certain aspects of the present disclosure. As shown, the auxiliary coils 804A, 804B provide an extra turn within the interiors of the double-D coils 802A, 802B that produce the side lobe magnetic fields.

In certain aspects, the auxiliary coils of the power transfer device may be implemented as one or more solenoid coils that reduce the magnetic field emissions of the double-D coils. That is, the auxiliary coils may be configured to form one or more solenoid coils. For example, FIG. 9A is a schematic diagram of an exemplary power transfer device 900 utilizing solenoid coils 904A, 904B as the auxiliary coils, in accordance with certain aspects of the present disclosure. As shown, the solenoid coils 904A, 904B are arranged on the periphery of the double-D coils 902A, 902B and coupled in series with the double-D coils 902A, 902B. The solenoid coils 904A, 904B may be single-turn coils or multi-turn coils.

FIG. 9B depicts a cross-sectional view of the winding paths across the line segment A-A′ of FIG. 9A, in accordance with certain aspects of the present disclosure. As shown, the solenoid coils 904A, 904B may be wound around the ferrite layer 906 and arranged orthogonal to the double-D coils 902A, 902B. That is, the auxiliary coils may be configured to form the solenoid coils 904A, 904B orthogonal to the double-D coils 902A, 902B.

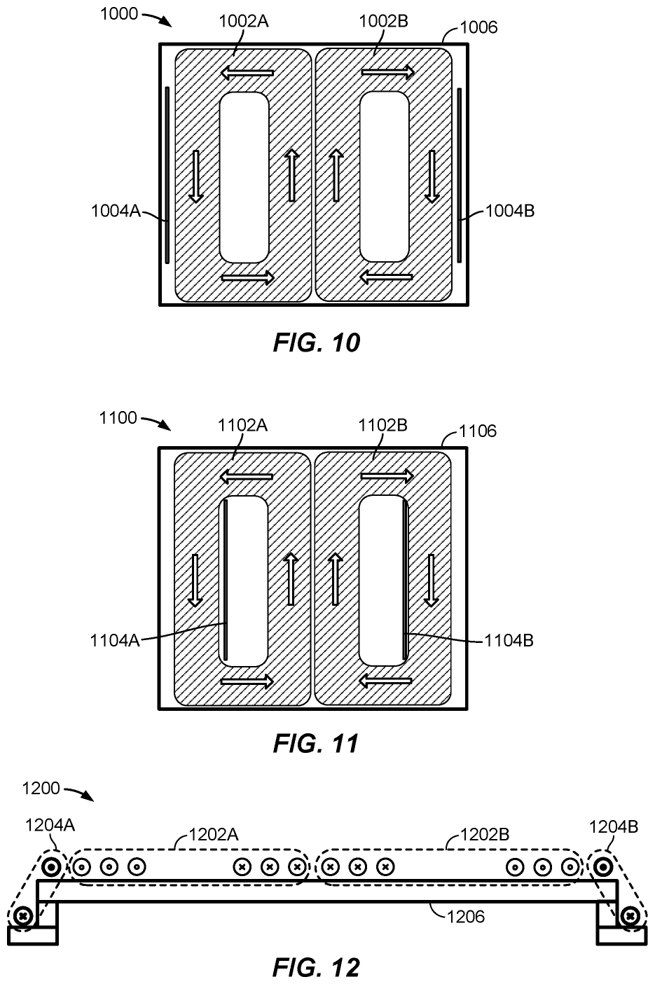

In certain aspects, the solenoid coil may span a portion of the double-D coupler. For example, FIG. 10 depicts a layout of an exemplary power transfer device 1000, where the solenoid coils are shorter than the double-D coils, in accordance with certain aspects of the present disclosure. As shown, the solenoid coils 1004A, 1004B only span a portion of the double-D coils 1002A, 1002B. That is, a length of the solenoid coils 1004A, 1004B may be less than a length of the double-D coils 1002A, 1002B.

In certain aspects, the solenoid coil(s) may be positioned in the interior of the individual D coil(s) of the double-D coupler. For example, FIG. 11 depicts a schematic diagram of an exemplary power transfer device 1100 having solenoid coils arranged in the interiors of the coils of the double-D coupler, in accordance with certain aspects of the present disclosure. As shown, the solenoid coils 1104A, 1104B are each arranged inside one of the double-D coils 1102A, 1102B, such that the solenoid coils 1104, 1104B are closer to the side lobe magnetic fields than the main magnetic field of the double-D coils 1102A, 1102B.

In certain aspects, the solenoid coil may be tilted relative to a plane of the coils of the double-D coupler. That is, the auxiliary coils may be configured to form one or more solenoid coils angled relative to the double-D coils. For example, FIG. 12 depicts a cross-sectional view of an exemplary power transfer device 1200 having tilted solenoid coils 1204A, 1204B, in accordance with certain aspects of the present disclosure. As shown, the solenoid coils 1204A, 1204B are arranged on the periphery of the double-D coils 1202A, 1202B and angled relative to the double-D coils 1202A, 1202B.

In certain aspects, the power transfer device of the present disclosure may include one or more auxiliary coils and/or solenoid coils in any of the arrangements described herein with respect to FIGS. 4A, 4B, 5A, 5B, 8, 9A, 9B, and 10-12.

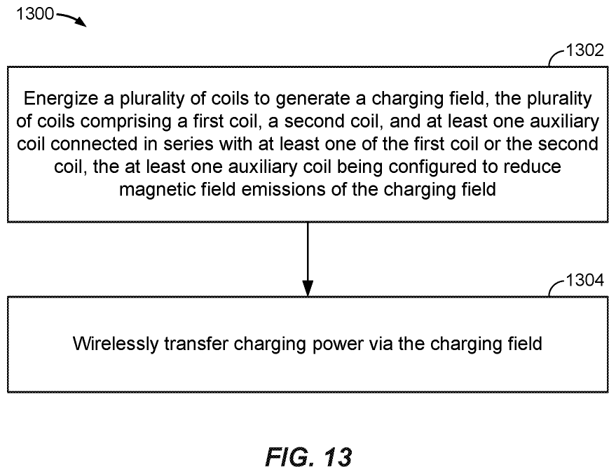

FIG. 13 is a flowchart illustrating example operations 1300 for reducing magnetic field emissions of a power transfer device. For example, the operations 1300 may be performed by a power transfer device (e.g., the base power transfer element 104 or the electric vehicle power transfer element 116 of FIG. 1).

Operations 1300, begin at block 1302, with a power transfer device (e.g., the power transfer device 400) energizing a plurality of coils to generate a charging field. The plurality of coils includes a first coil, a second coil, and an auxiliary coil, which is coupled in series with at least one of the first coil or the second coil. The auxiliary coil is configured to reduce magnetic field emissions of the charging field as described herein. The plurality of coils may be any of the coils described herein with respect to FIGS. 4A, 4B, 5A, 5B, 8, 9A, 9B, and 10-12. At block 1304, the power transfer device wirelessly transfers charging power via the charging field to a wireless power receiver (e.g., vehicle power transfer element 116, 216, 316).

In certain aspects, the power transfer device described herein may also receive power as a wireless power receiver (e.g., a vehicle power transfer element 116, 216, 316). For instance, the receiver pad 640 illustrated in FIGS. 6 and 7 may include auxiliary coils as described herein.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

1. A power transfer device, comprising:
a first coil and a second coil configured to generate a charging field; and
at least one auxiliary coil coupled in series with at least one of the first coil or the second coil, the at least one auxiliary coil being configured to reduce magnetic field emission of the charging field.

2. The power transfer device of claim 1, wherein the first and second coils form a double-D coil.

3. The power transfer device of claim 1, wherein the first coil is coupled in series with the second coil and wherein the first coil is arranged adjacent to the second coil, such that an electric current is configured to flow in a same direction in adjacent turns of the first and second coils.

4. The power transfer device of claim 3, wherein the first coil comprises a first spiral wound in a clockwise direction, and wherein the second coil comprises a second spiral wound in a counterclockwise direction.

5. The power transfer device of claim 1, wherein the at least one auxiliary coil comprises a single-turn coil.

6. The power transfer device of claim 1, wherein the at least one auxiliary coil comprises a multi-turn coil.

7. The power transfer device of claim 1, wherein the at least one auxiliary coil comprises a first auxiliary coil coupled in series with the first coil and a second auxiliary coil coupled in series with the second coil.

8. The power transfer device of claim 1, wherein the at least one auxiliary coil is configured to form a solenoid coil angled relative to the first and second coils.

9. The power transfer device of claim 1, wherein the at least one auxiliary coil is configured to form a solenoid coil orthogonal to the first and second coils.

10. The power transfer device of claim 1, wherein the at least one auxiliary coil includes a winding path such that a first portion of the winding path is laterally spaced closer to a main magnetic flux of the charging field than a second portion of the winding path.

11. The power transfer device of claim 1, further comprising a layer of ferrite material below the first and second coils.

12. The power transfer device of claim 11, wherein the at least one auxiliary coil includes a winding path such that at least a portion of the winding path travels below the layer of ferrite material.

13. The power transfer device of claim 1, wherein the at least one auxiliary coil includes a current path that travels in a same direction as a winding direction of at least one of the first coil or the second coil.

14. The power transfer device of claim 1, wherein the power transfer device is configured to perform wireless electric vehicle charging.

15. An apparatus for wireless electric vehicle charging, comprising:
a first coil and a second coil configured to generate a charging field;
a layer of ferrite material below the first and second coils; and
at least one auxiliary coil coupled in series with at least one of the first coil or the second coil, the at least one auxiliary coil being configured to reduce magnetic field emissions of the charging field.

16. The apparatus of claim 15, wherein the first and second coils form a double-D coil.

17. The apparatus of claim 15, wherein the first coil is coupled in series with the second coil and wherein the first coil is arranged adjacent to the second coil, such that an electric current is configured to flow in a same direction in adjacent turns of the first and second coils.

18. The apparatus of claim 15, wherein the at least one auxiliary coil comprises a first auxiliary coil coupled in series with the first coil and a second auxiliary coil coupled in series with the second coil.

19. The apparatus of claim 15, wherein the apparatus is a base pad configured to energize a vehicle pad.

20. A method of wireless electric charging, comprising:
energizing a plurality of coils to generate a charging field, the plurality of coils comprising a first coil, a second coil, and at least one auxiliary coil coupled in series with at least one of the first coil or the second coil, the at least one auxiliary coil being configured to reduce magnetic field emissions of the charging field; and
wirelessly transferring charging power via the charging field.
